(19) United States
(12) Patent Application Publication
(10) Pub. No.: US 2015/0242102 A1
(43) Pub. Date: Aug. 27, 2015

(54) MANIPULATING APPARATUS

(71) Applicant: DENSO CORPORATION, Kariya-city, Aichi (JP)

(72) Inventors: Kazuya Enami, Kariya-city (JP); Shigeaki Nishihashi, Nagoya-city (JP)

(21) Appl. No.: 14/427,732

(22) PCT Filed: Aug. 2, 2013
(86) PCT No.: PCT/JP2013/004701

§ 371 Date: Mar. 12, 2015

(30) Foreign Application Priority Data
Oct. 2, 2012 (JP) 2012-220661

(51) Int. Cl. G06F 3/0484; G06F 3/0488; G06F 3/044

(52) U.S. Cl. CPC G06F 3/04845; G06F 3/044; G06F 3/0488

(57) ABSTRACT

A manipulating apparatus includes a manipulation control portion and a touch sensor detecting manipulation to a first manipulation surface by a manipulator's finger, while acquiring a manipulation body distance from the first manipulation surface to the finger. The manipulation in a first manipulation space where the manipulation body distance is less than a first threshold distance is distinguished from the manipulation in a second manipulation space where the manipulation body distance is not less than the first threshold distance. The first movement of the finger in the first manipulation space and the second movement of the finger in the second manipulation space are respectively associated with a focus and a submenu image, to change their display modes. To assist an input by the finger in the second manipulation space, a second manipulation surface is formed to a location apart from the first manipulation surface by a first threshold distance or more.

### CROSS REFERENCE TO RELATED APPLICATION

The present disclosure is based on Japanese Patent Application No. 2012-220661 filed on Oct. 2, 2012, the disclosure of which is incorporated herein by reference.

### TECHNICAL FIELD

The present disclosure relates to a manipulating apparatus that manipulates an image portion displayed on a display screen by an input to a manipulation portion.

### BACKGROUND ART

Patent Literature 1 discloses the art of moving image portions on a display screen, such as a pointer of a navigation display and a radio main screen, in association with manipulations performed to a remote touch pad portion. A user interface apparatus disclosed in Patent Literature 1 includes a remote touch pad portion that detects the manipulation to move a finger of a manipulator and a control portion that associates the manipulation of the finger detected by the remote touch pad portion with movement of a map and a pointer.

In addition, the control portion acquires the distance from the remote touch pad portion to the finger. When the acquired distance to the finger is less than a predefined height, for example, three centimeters (cm), the control portion associates the manipulation by the finger detected by the remote touch pad portion with the manipulation that moves the pointer on the display screen. In contrast, when the distance to the finger acquired by the control portion is a predefined height, for example, in the range from 5 cm to 7 cm, the control portion associates the manipulation by the finger detected by the remote touch pad portion with the switching manipulation that switches from a radio main screen to a manipulation wait screen.

### PRIOR ART LITERATURES

### Patent Literature

Patent Literature 1: JP 2011-118857 A

### SUMMARY OF INVENTION

Now, the manipulating apparatus of Patent Literature 1 does not provide any configuration that assists the input by the finger of a manipulator for switching the radio main screen to the manipulation wait screen. Therefore, it is difficult for the manipulator to obtain the range in which the switching control is performable. Thus, when the range in which the switching control is performable is unclear, it may be difficult for the manipulator to easily perform the input for the switching manipulation.

It is an object of the present disclosure to provide a manipulating apparatus that makes easy the input by a manipulator in a manipulation space spaced apart from a manipulation portion.

To achieve the above object, a manipulating apparatus according to a first aspect of the present disclosure is provided as follows. The manipulating apparatus manipulates an image displayed on a display screen by an input with a manipulation body performed to a manipulation surface. The manipulating apparatus includes a detection device, an acquisition device, an association device, and an input auxiliary portion. The detection device detects movement of the manipulation body. The acquisition device acquires a manipulation body distance from the manipulation surface to the manipulation body. The association device distinguishes a first movement of the manipulation body detected in a first manipulation space in which the manipulation body distance is less than a predefined threshold distance from a second movement of the manipulation body detected in a second manipulation space in which the manipulation body distance is greater than the predefined threshold distance. The association device associates the first movement of the manipulation body and the second movement of the manipulation body, respectively, with a first image portion displayed on the display screen and a second image portion displayed on the display screen; the second image portion is different from the first image portion. The association device changes a display mode of at least one of the first image portion and the second image portion. The input auxiliary portion is formed to a location spaced apart from the manipulation surface by a distance equal to or greater than the threshold distance.

According to this configuration, when an input is made in a second manipulation space in which movement of a manipulation body is associated with a second image, a manipulator can receive an input assistance by contacting an input auxiliary portion formed apart from a manipulation surface by a threshold distance. Because of such assistance, the manipulator can easily obtain the location of the second manipulation space defined apart from the manipulation surface. Therefore, the manipulator can easily perform the input in the second manipulation space.

A manipulating apparatus according to a second aspect of the present disclosure is provided to include a plane-shaped capacitive touch panel and a guide portion that covers part of the capacitive touch panel and guides input manipulation to the capacitive touch panel.

A manipulating apparatus according to a third aspect of the present disclosure is provided as follows. The manipulating apparatus manipulates an image displayed on a display screen by an input with a manipulation body performed to a manipulation surface. The manipulating apparatus including: means for detecting movement of the manipulation body; means for acquiring a manipulation body distance from the manipulation surface to the manipulation body; means for distinguishing a first movement of the manipulation body detected in a first manipulation space in which the manipulation body distance is less than a predefined threshold distance from a second movement of the manipulation body detected in a second manipulation space in which the manipulation body distance is greater than the predefined threshold distance, associating the first movement of the manipulation body and the second movement of the manipulation body, respectively, with a first image portion displayed on the display screen and a second image portion displayed on the display screen, the second image portion being different from the first image portion, and changing a display mode of at least one of the first image portion and the second image portion; and means for assisting the second movement of the manipulation body in the second manipulation space.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram for explaining a configuration of a display system including a remote manipulating apparatus of a first embodiment of the present disclosure;

FIG. 2 is a diagram for explaining an arrangement of a display screen and a manipulation surface in a passenger cabin of a vehicle;

FIG. 3 is a diagram for explaining one example of a display image displayed on the display screen;

FIG. 4 is a diagram for explaining that the display image is formed by superimposing rendering layers;

FIG. 5 is a perspective view of the remote manipulating apparatus of the first embodiment;

FIG. 6 is a diagram for explaining the configuration of the remote manipulating apparatus of the first embodiment, and is a sectional view taken along line VI-VI of FIG. 5;

FIG. 7 is a diagram for explaining that an image portion targeted for manipulations is switched based on a manipulation body distance in the remote manipulating apparatus of the first embodiment;

FIG. 8 is a diagram for explaining a series of icon selection manipulations by a manipulator;

FIG. 9 is a flowchart showing a manipulation mode selection performed by a manipulation control portion in the remote manipulating apparatus of the first embodiment;

FIG. 10 is a diagram for explaining relationship between a sensitivity value detected by a touch sensor and a manipulation state determined by the manipulation control portion in the remote manipulating apparatus of the first embodiment;

FIG. 11 is a diagram showing each sensibility threshold stored in the manipulation control portion of the first embodiment;

FIG. 12 is a perspective view of a remote manipulating apparatus of a second embodiment;

FIG. 13 is a diagram for explaining a configuration of the remote manipulating apparatus of the second embodiment, and is a sectional view taken along line XIII-XIII of FIG. 12;

FIG. 14 is a diagram for explaining a series of icon selection manipulations by the manipulator;

FIG. 15 is a sectional view for explaining a configuration of a remote manipulating apparatus of a third embodiment;

FIG. 16 is a diagram for explaining a series of icon selection manipulations by the manipulator;

FIG. 17 is a flowchart showing a manipulation mode selection performed by a manipulation control portion in the remote manipulating apparatus of the third embodiment;

FIG. 18 is a sectional view for explaining a configuration of a remote manipulating apparatus of a fourth embodiment;

FIG. 19 is a sectional view for explaining a configuration of a remote manipulating apparatus of a fifth embodiment;

FIG. 20 is a sectional view for explaining a configuration of a remote manipulating apparatus of a sixth embodiment; and

FIG. 21 is a diagram showing a modification of FIG. 19.

### EMBODIMENTS FOR CARRYING OUT INVENTION

Hereafter, multiple embodiments of the present disclosure are described based on the figures. The same reference numerals designate corresponding components in each embodiment, and repetitive explanation may be therefore omitted. When only part of a configuration is explained in each embodiment, configurations of other embodiments already explained can be applied to the other part of the configuration. Not only specified combinations of configurations in explanation of each embodiment, but also sub-combinations of configurations of multiple embodiments, though not specified, are possible when there is no difficulty in the combinations. Non-specified combinations of configurations described in multiple embodiments and modifications are also disclosed in the following explanation.

### First Embodiment

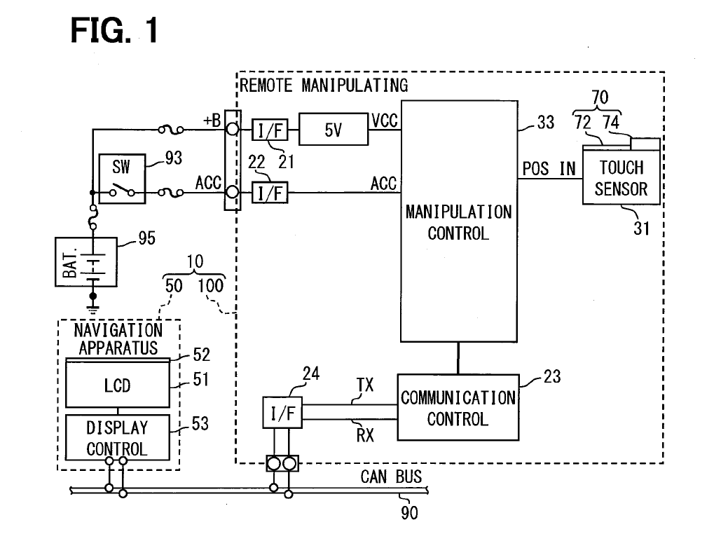

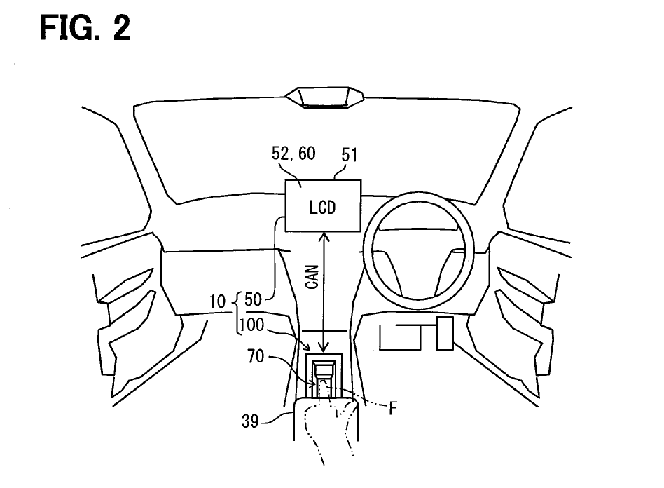

A remote manipulating apparatus 100 of a first embodiment of the present disclosure is mounted to a vehicle, and configures a display system 10 together with a navigation apparatus 50 as shown in FIG. 1. The remote manipulating apparatus 100 is installed adjacently to a palm rest 39 in a center console of the vehicle as shown in FIG. 2 to expose a manipulation surface 70 easily accessible by the hand of a manipulator. The manipulation by the forefinger (hereinafter called just a “finger”) F of the manipulator is input to the manipulation surface 70. The navigation apparatus 50 is installed in an instrument panel of the vehicle such that a display screen 52 is exposed to be visible from the manipulator and the display screen 52 is located to be visible from the driver's seat. Various display images 60 are displayed on the display screen 52.

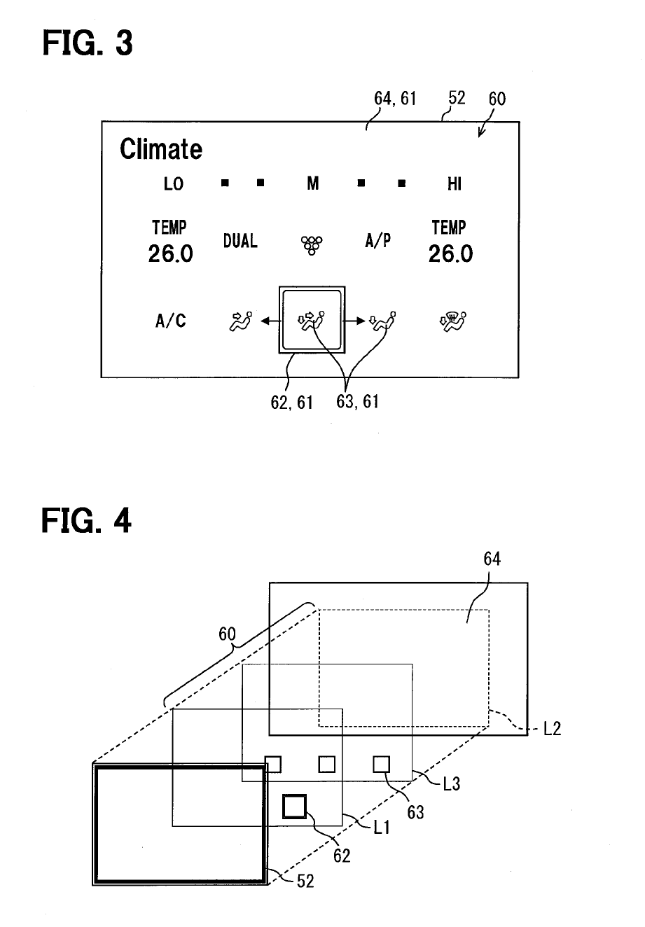

The display image 60 shown in FIG. 3 is one of multiple display images displayed on the display screen 52, and shows an air conditioner menu image to manipulate an air conditioner mounted to the vehicle. The display image 60 includes multiple icons 63 associated with predetermined functions, a focus 62 for selecting the icons 63, and a background portion 64 that is a background of the icons 63 and focus 62. The location to display the focus 62 on the display screen 52 corresponds to the location in contact with the finger F on the manipulation surface 70 shown in FIG. 2.

As shown in FIG. 4, the above display images 60 are generated by superimposition of multiple rendering layers by the navigation apparatus 50 (see FIG. 1). Specifically, the display images 60 are generated by superimposing a background layer L2 to render the background portion 64, an object layer L3 to render the icons 63, and a focus layer L1 to render the focus 62. Each layer L1 to L3 is defined to be sized to the display screen 52.

Next, configurations of the remote manipulating apparatus 100 and navigation apparatus 50 shown in FIG. 1 are explained in detail.

The remote manipulating apparatus 100 is connected to a Controller Area Network (CAN) bus 90 and an external battery 95. The CAN bus 90 is a transmission path used for data transmission between each vehicle-mounted apparatus in an in-vehicle communication network that connects multiple vehicle-mounted apparatuses to each other. The remote manipulating apparatus 100 is capable of communicating with the navigation apparatus 50 separate therefrom by CAN communication via the CAN bus 90.

The remote manipulating apparatus 100 includes power interfaces 21 and 22, a communication control portion 23, a communication interface 24, a touch sensor 31, and a manipulation control portion 33. The power interfaces 21 and 22 stabilize electric power supplied from the battery 95 to supply the power to the manipulation control portion 33. Power is always supplied to the power interface 21 from the battery 95. When a switch 93 is electrically conductive upon turn-on of an accessory (ACC) power of the vehicle, power is supplied from the battery 95 to the power interface 22.

The communication control portion 23 and communication interface 24 output the information processed by the manipulation control portion 33 to the CAN bus 90 and acquires the information outputted from other vehicle-mounted apparatuses to the CAN bus 90. The communication control portion 23 and communication interface 24 are connected to each other by a signal line TX for transmission and a signal line RX for reception.

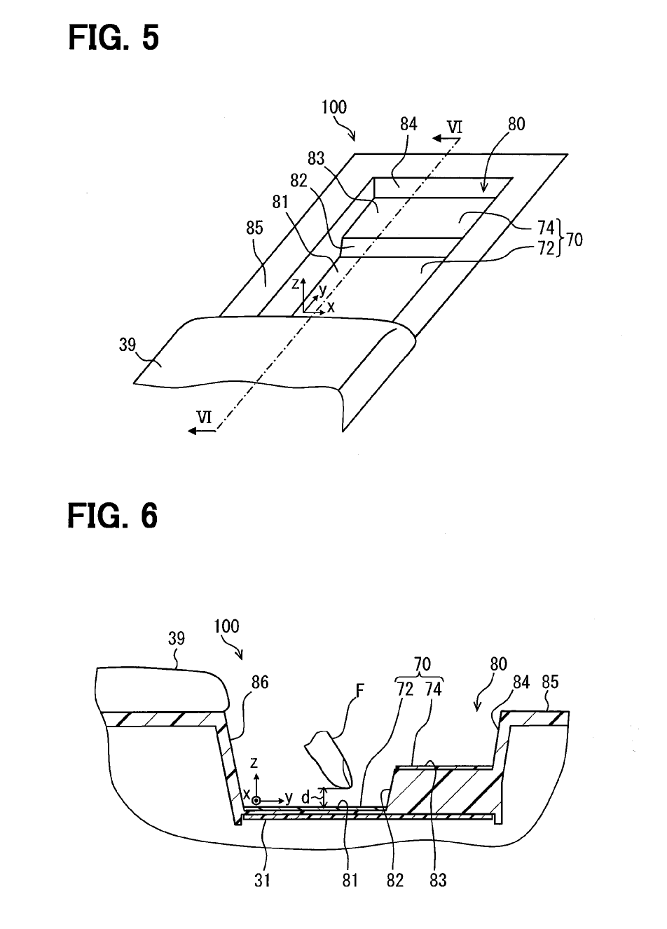

As shown in FIGS. 1 and 2, a touch sensor 31 is capacitive, and formed in a rectangular, plane shape. The touch sensor 31 is also called a touch panel 31. The touch sensor 31 is formed by arranging electrodes extending in the x-axis direction and electrodes extending in the y-axis direction in a lattice form in FIG. 5. As shown in FIG. 1, the touch sensor 31 is connected to the manipulation control portion 33. The touch sensor 31 detects manipulation to the manipulation surface 70 by the finger F (see FIG. 2), and outputs the detection to the manipulation control portion 33.

The manipulation control portion 33 is also called a control circuit 33, and includes a processor for various arithmetic processing, a RAM that functions as an area for the arithmetic processing, and a flash memory that stores programs for the arithmetic processing. In addition, the manipulation control portion 33 is connected to the power interfaces 21 and 22, communication control portion 23, and touch sensor 31.

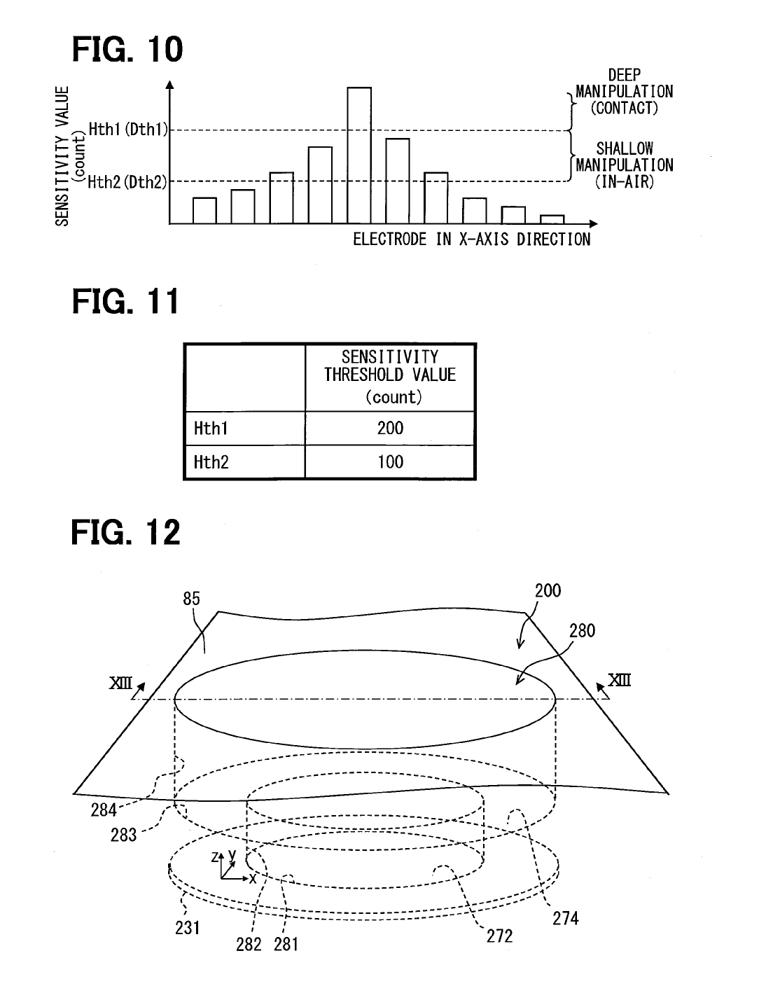

Charge is stored between the finger F and the electrodes of the touch sensor 31 that are proximate to each other as shown in FIG. 6. The manipulation control portion 33 shown in FIG. 1 acquires a sensitivity value (see FIG. 10) of the sensor 31 by executing a predetermined program and measuring an electric potential of each electrode of the touch sensor 31. The manipulation control portion 33 detects an x-coordinate and y-coordinate that show a relative location of the finger F relative to the manipulation surface 70 and a z-coordinate equivalent to a distance (hereinafter called a “manipulation body distance d”) from the manipulation surface 70 to the finger F by the calculation based on the sensitivity value. The manipulation control portion 33 outputs the x-coordinate and y coordinate that show the relative location of the finger F to the CAN bus 90 via the communication control portion 23 and communication interface 24.

The navigation apparatus 50 shown in FIGS. 1 and 2 is connected to the CAN bus 90 to be in communication with the remote manipulating apparatus 100. The navigation apparatus 50 has a display control portion 53 and a liquid crystal display 51.

The display control portion 53 includes a processor that performs various arithmetic processing, a RAM that functions as a work area for the arithmetic processing, a graphic processor that performs rendering of images, and a graphic RAM that functions as a work area for rendering of images. In addition, the display control portion 53 has a flash memory to store data used for arithmetic processing and rendering, a communication interface connected to the CAN bus 90, and an image output interface to output data of rendered images to the liquid crystal display 51. The display control portion 53 renders the display images 60 to be displayed on the display screen 52 based on the information acquired from the CAN bus 90. The display control portion 53 outputs the image data of the rendered display images 60 to the liquid crystal display 51 one after another via the image output interface.

The liquid crystal display 51 is a dot matrix type display to realize color display by controlling multiple pixels arranged on the display screen 52. The liquid crystal display 51 displays images by forming sequentially image data acquired successively from the display control portion 53 on the display screen 52.

Next, the configuration of the manipulation surface 70 is explained in more detail based on FIGS. 5 and 6.

The manipulation surface 70 is formed to a recessed portion 80 provided to the remote manipulating apparatus 100. The recessed portion 80 is recessed in a rectangular shape from a periphery surface 85 surrounding the periphery of the recessed portion 80. The recessed portion 80 includes: a first bottom surface 81 and a second bottom surface 83 between which a level difference is provided; and multiple side wall surfaces 82, 84, and 86. The first bottom surface 81 and second bottom surface 83 are formed in a plane shape along the x-y plane. The first bottom surface 81 is formed to a deeper position than the second bottom surface 83 relative to the periphery surface 85. The second bottom surface 83 is formed to the intermediate position between the first bottom surface 81 and periphery surface 85 in the z-axis direction. The second bottom surface 83 is formed toward the front in the travel direction of the vehicle in the y-axis direction.

An intermediate side wall surface 82 is formed between the first bottom surface 81 and second bottom surface 83. The intermediate side wall surface 82 slopes toward the outer periphery of the first bottom surface 81 as it is separate from the first bottom surface 81 along the z-axis direction. A front side wall surface 84 is formed between the second bottom surface 83 and periphery surface 85. The front side wall surface 84 slopes toward the outer periphery of the second bottom surface 83 as it is separate from the second bottom surface 83 along the z-axis direction. A back side wall surface 86 is formed between the first bottom surface 81 and periphery surface 85. The back side wall surface 86 slopes toward the outer periphery of the first bottom surface 81 as it is separate from the first bottom surface 81 along the z-axis direction.

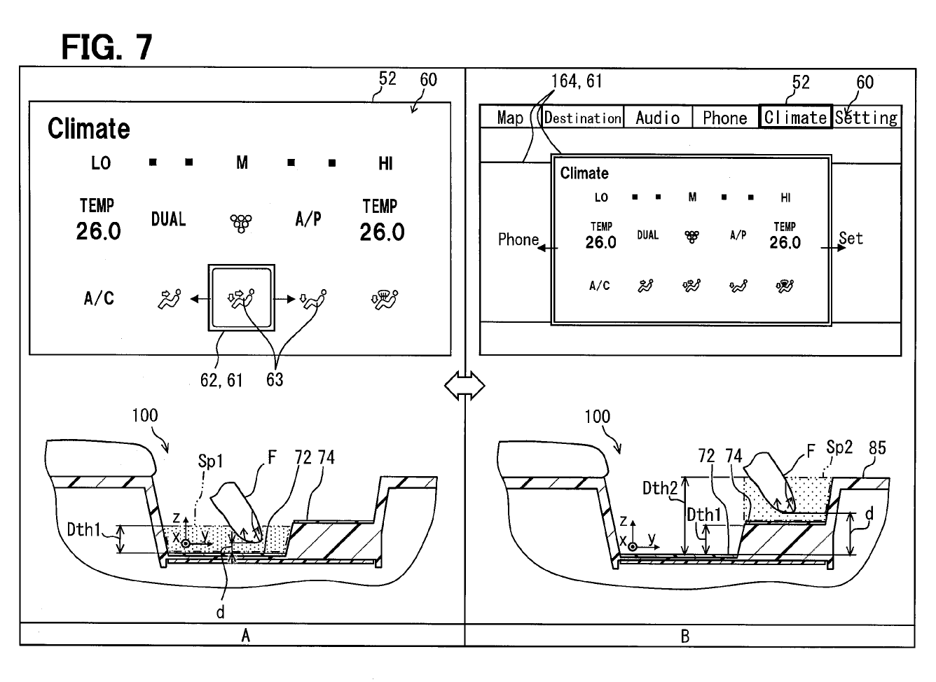

The manipulation surface 70 formed to the above recessed portion 80 includes a first manipulation surface 72 and a second manipulation surface 74. The first manipulation surface 72 is formed to the first bottom surface 81 in a rectangular shape. The second manipulation surface 74 is formed to the second bottom surface 83 in a rectangular shape, and separate from the first manipulation surface 72 by a distance equal to greater than first threshold distance Dth1 (see FIG. 7 (A)). The area of the second manipulation surface 74 is made smaller than the first manipulation surface 72.

The touch sensor 31 opposes the overall areas of the first manipulation surface 72 and the second manipulation surface 74 in the z axis direction. Thus, the touch sensor 31 is capable of detecting not only the moving manipulation of moving the finger F in the area opposing the first manipulation surface 72 but also the moving manipulation of moving the finger F in the area opposing the second manipulation surface 74. Therefore, the second manipulation surface 74 covers a partial area of the capacitive touch sensor (31), and functions also as a guide portion that guides input manipulation to the capacitive touch sensor (31).

In the remote manipulating apparatus 100 explained above, the manipulation mode is changed in response to: a relative location of the finger F that inputs the moving manipulation; and the manipulation body distance d. This changes image portions 61 associated with the moving manipulation of the finger F in the display images 60, as shown in FIG. 7. Hereafter, the following manipulation modes of (1) to (3) predefined in the remote manipulating apparatus 100 are explained in detail.

(1) Deep Manipulation Mode

In a deep manipulation mode, as shown in FIG. 7 (A), the moving manipulation by the finger F is associated with a focus control to move the focus 62 of the display screen 52. In such a deep manipulation mode, the finger F is located in a first manipulation space Sp1. The first manipulation space Sp1 is a space where the manipulation body distance d is less than the first threshold distance Dth1, and defined in the area opposing the first manipulation surface 72. The first threshold distance Dth1 is slightly shorter than the size of the level difference between the first manipulation surface 72 and second manipulation surface 74, and set to, for example, about 0.5 to 1 cm.

The moving manipulation to move the finger F along the x-y plane in the above first manipulation space Sp1 is defined as a “deep manipulation,” and is capable of moving the position of the focus 62 displayed on the display screen 52.

(2) Shallow Manipulation Mode

In a shallow manipulation mode, as shown in FIG. 7 (B), the moving manipulation by the finger F is associated with scrolling controls to horizontally move (hereinafter called “scroll”) multiple submenu images 164 of the display screen 52. In such a shallow manipulation mode, the finger F is located in a second manipulation space Sp2. The second manipulation space Sp2 is a space where the manipulation body distance d is equal to or greater than the first threshold distance Dth1 and less than a second threshold distance Dth2, and defined in the area opposing the second manipulation surface 74. The second threshold distance Dth2 is slightly shorter than the depth from the periphery surface 85 to the first manipulation surface 72, and set to, for example, about 2 to 3 cm.

When the finger F is located in the above second manipulation space Sp2, the display screen 52 is changed such that the multiple submenu images 164 including the air conditioning menu image are selectable. Under such a state, the moving manipulation to move the finger F along the x-y plane is defined as a “shallow manipulation” to be capable of scrolling the multiple submenu images 164 displayed on the display screen 52.

Additionally, by setting the above first threshold distance Dth1 and second threshold distance Dth2, the second manipulation surface 74 is located closer to the second manipulation space Sp2 than the first manipulation surface 72, and located in the second manipulation space Sp2. Therefore, a manipulator can perform the shallow manipulation with the finger F contacting the second manipulation surface 74. Thus, the second manipulation surface 74 is capable of assisting the input by the finger F in the second manipulation space Sp2.

(3) Non-adjacent Mode

The moving manipulation by the finger F is not associated with any of the image portions 61 of the display screen 52 in the non-adjacent mode. In such a non-adjacent mode, the finger F is not located in the first manipulation space Sp1 (see FIG. 7 (A)) or second manipulation space Sp2. Thus, the space except for the first manipulation space Sp1 and second manipulation space Sp2 is set as a non-adjacent space.

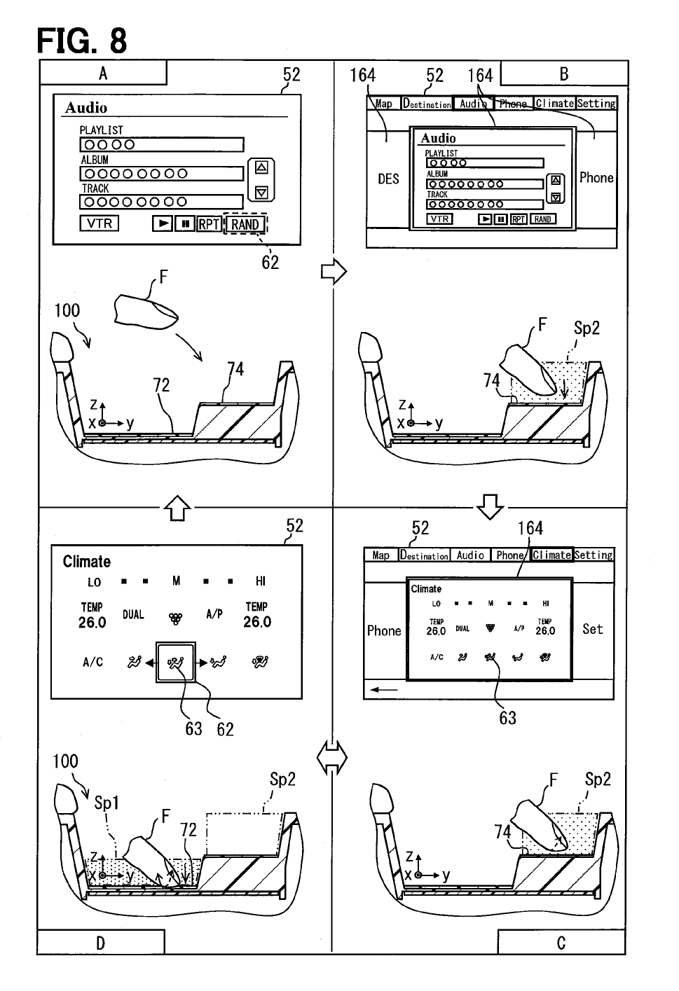

As explained above, in the display system 10 (see FIG. 1), the movement of the finger F detected in the first manipulation space Sp1 and the movement of the finger F detected in the second manipulation space Sp2 are distinguished from each other. In such a configuration, a series of icon selecting manipulations until the manipulator selects the arbitrary icon 63 (see FIG. 8 (A)) is explained sequentially based on FIG. 8.

FIG. 8 (A) shows a state in which the manipulator has started making the finger F approach each of the manipulation surfaces 72 and 74. Thus, the manipulator who is going to start an icon selecting manipulation moves the finger F located remote from the first manipulation surface 72 and second manipulation surface 74 toward each of the manipulation surfaces 72 and 74. In the state shown in FIG. 8 (A), since the remote manipulating apparatus 100 is in the wait state, the movement associated with the finger F for the focus 62 of the display screen 52 is not performed.

FIG. 8 (B) shows the finger F moved into the second manipulation space Sp2 from the non-adjacent space. Under this state, the manipulator's inputting a touch (hereinafter called a “tap”) on the second manipulation surface 74 can start the association between the shallow manipulation by the finger F and the scroll control. In this way, by setting the manipulation mode to the shallow manipulation mode, the display screen 52 is switched to the state in which the multiple submenu images 164 are scrollable.

In FIG. 8 (C), the manipulator inputs a drag on the second manipulation surface 74 with the finger F to the second manipulation surface 74. The manipulator can move the submenu images 164 containing the arbitrary icon 63 (for example, air conditioning menu image) toward the center of the display screen 52 by the shallow manipulation in the second manipulation space Sp2 where the finger F is moved along the x-axis direction.

FIG. 8 (D) shows the finger F moved from the second manipulation space Sp2 to the first manipulation space Sp1 on and over the first manipulation surface 72. When the finger F moves into the first manipulation space Sp1, the manipulation mode of the remote manipulating apparatus 100 is changed from the shallow manipulation mode to the deep manipulation mode. Thereby, the moving manipulation is associated with the focus control; the submenu image 164 (air conditioning menu image, see FIG. 8 (C)) displayed on the center portion of the display screen 52 is displayed on the entirety of the display screen 52.

Under the above state, the manipulator can superimpose the focus 62 on the arbitrary icon 63 by inputting the deep manipulation of dragging the first manipulation surface 72 with the finger F. The manipulator can select this arbitrary icon 63 by inputting a tap to the first manipulation surface 72 with the focus 62 superimposed on the arbitrary icon 63.

As shown in FIG. 8 (A), the manipulator who has completed the selection of the icon 63 moves the finger F to the non-adjacent space. Thereby, the manipulation mode is changed to the non-adjacent mode. When a predefined threshold time Tth has elapsed after the manipulation mode is changed to the non-adjacent mode, the remote manipulating apparatus 100 enters the wait state to wait for the subsequent selection of the icons by the manipulator.

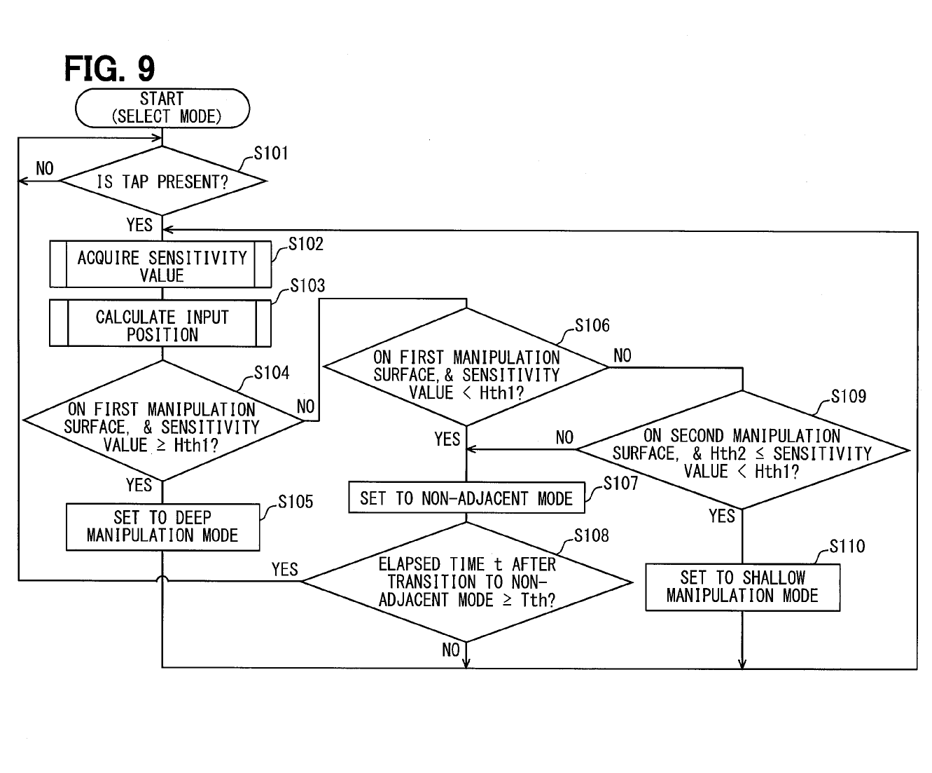

To realize the above icon selection, the manipulation mode selection performed by the manipulation control portion 33 is explained in detail based on FIGS. 9 to 11. The manipulation mode selection shown in FIG. 9 is started by the manipulation control portion 33 (see FIG. 1) by turning on an ACC power of the vehicle.

It is noted that a flowchart or the processing of the flowchart in the present application includes sections (also referred to as steps), each of which is represented, for instance, as S101. Further, each section can be divided into several sub-sections while several sections can be combined into a single section. Furthermore, each of thus configured sections can be also referred to as a device, module, or means. Each or any combination of sections explained in the above can be achieved as (i) a software section in combination with a hardware unit (e.g., computer) or (ii) a hardware section (e.g., integrated circuit, hard-wired logic circuit), including or not including a function of a related apparatus; furthermore, the hardware section may be constructed inside of a microcomputer.

In S101, the presence of a tap on any one of the first manipulation surface 72 and second manipulation surface 74 is determined based on variation in the output acquired from the touch sensor 31. When it is determined that there is no tap in S101, the wait state of the remote manipulating apparatus 100 is maintained by repeating the determination of S101. On the other hand, when it is determined that there is a tap in S101, the flow proceeds to S102.

In S102, the sensitivity value detected in each electrode of the touch sensor 31 is acquired, and the flow proceeds to S103. In S103, by use of the sensitivity value acquired in S102, the calculation of the x-coordinate, y-coordinate, and z-coordinate (hereinafter, “input position coordinate”) that show a three dimensional location of the finger F relative to a manipulation surface 32 is performed, and the flow proceeds to S104.

The calculation executed in S103 is explained in detail based on FIG. 10. The sensitivity value becomes greater as the capacitance stored between the manipulation surface 32 and finger F increases. Therefore, the coordinates in the x-axis direction and y-axis direction at which the sensitivity value is the maximum show a relative position of the finger F on the first manipulation surface 72 and second manipulation surface 74. In addition, the sensitivity value decreases as the manipulation body distance d (see FIG. 7 (A)) becomes shorter, and the value increases as the manipulation body distance d becomes longer. Therefore, the maximum sensitivity value corresponds to the manipulation body distance d and the coordinate in the z-axis direction.

As shown in FIG. 11, a sensibility threshold Hth1 corresponding to the first threshold distance Dth1 and a sensibility threshold Hth2 corresponding to the second threshold distance Dth2 are beforehand stored in the manipulation control portion 33 (see FIG. 1). In the processing after S104 shown in FIG. 9, the manipulation control portion 33 compares the maximum sensitivity value acquired in S103 to each of the sensibility thresholds Hth1 and Hth2.

In S104, it is determined whether the finger F is in the first manipulation space Sp1. That is, it is determined whether the relative position of the finger F is on the first manipulation surface 72 and the sensitivity value is the first sensibility thresholds Hth1 or greater. When a positive determination is made in S104, the flow proceeds to S105. In S105, the manipulation mode is set to the deep manipulation mode, and the flow returns to S102.

In S106 when a negative determination is made in S104, it is determined whether the relative position of the finger F is on the first manipulation surface 72 and the sensitivity value is less than the first sensibility threshold Hth1. When a positive determination is made in S106, the flow proceeds to S107. In S107, the manipulation mode is set to the non-adjacent mode, and the flow proceeds to S108. In S107, when the manipulation mode is changed from any one of the deep manipulation mode and shallow manipulation mode to the non-adjacent mode, the count of an elapsed time t is started after the transition to the non-adjacent mode.

In S108, it is determined whether the elapsed time t that has started to be counted in S107 or before the previous S107 is equal to or greater than the predefined threshold time Tth. When a positive determination is made in S108, the flow returns to S101. Thereby, the remote manipulating apparatus 100 transitions to the wait state. On the other hand, when a negative determination is made in S108, the flow returns to S102.

In S109 when a negative determination is made in S106, it is determined whether the finger F is in the second manipulation space Sp2. That is, it is determined whether the relative position of the finger F is on the second manipulation surface 74 and the sensitivity value is less than the first sensibility threshold Hth1 and equal to or greater than the sensibility threshold Hth2. When a negative determination is made in S109, the finger F is estimated to be in the non-adjacent space, and the flow proceeds to the above S107. On the other hand, when a positive determination is made in S109, the flow proceeds to S110. In S110, the manipulation mode is set to the shallow manipulation mode, and the flow returns to S102.

The manipulation control portion 33 that has changed the manipulation mode in the above S105, S107, and S110 outputs a command signal to notify the CAN bus 90 of the change of the manipulation mode via the communication control portion 23 and communication interface 24. The display control portion 53 that has acquired this command signal activates the rendering layer corresponding to each manipulation mode based on the signal.

Specifically, when the manipulation control portion 33 sets the manipulation mode to the deep manipulation mode, the display control portion 53 selects the focus layer L1 as an active rendering layer. Thus, the manipulation control portion 33 is capable of changing or manipulating the display of the focus 62 while associating the deep manipulation by the finger F with the focus 62 (focus control). In other words, the display mode (including display contents, display position, display color, display shape, display type, display specification, and display size) of the focus 62 is changed.

In contrast, when the manipulation control portion 33 sets the manipulation mode to the shallow manipulation mode, the display control portion 53 selects submenu layers (not shown) that renders the multiple submenu images 164 as active rendering layers. Thus, the manipulation control portion 33 is capable of changing or manipulating the display of the submenu images 164 while associating the shallow manipulation by the finger F with the multiple submenu images 164 (scroll control). In other words, the display mode (including display contents, display position, display color, display shape, display type, display specification, and display size) of the submenu image 164 is changed.

Further, when the manipulation control portion 33 sets the manipulation mode to the non-adjacent mode, the display control portion 53 sets the active rendering layers to “absence.” Thereby, the moving manipulation of the finger F is not associated with any of the image portions 61.

According to the first embodiment described above, when the shallow manipulation is input in the second manipulation space Sp2, the manipulator makes the finger F contact the second manipulation surface 74 to be capable of receiving input assistance. Because of such assistance, the manipulator easily obtains the location of the second manipulation space Sp2 defined remote from the first manipulation surface 72. Therefore, the manipulator can easily perform the input in the second manipulation space Sp2.

Additionally, in the first embodiment, the manipulator can change the image portion 61 targeted for manipulation in the focus 62 and submenu images 164 by moving the finger F between the first manipulation surface 72 and second manipulation surface 74. Thus, the manipulator can more easily grasp each of the manipulation spaces Sp1 and Sp2 by dividing the first manipulation space Sp1 and second manipulation space Sp2 front to back along the z-x plane. Therefore, the manipulator can select a series of icons by blind manipulation without looking at the hand.

Additionally, according to the first embodiment, by forming each manipulation surface 71, 73 on each bottom surface 81, 83 of the recessed portion 80 provided to the remote manipulating apparatus 100, the manipulator can perform the input to each manipulation surface 72, 74 after stabilizing the hand by using the periphery surface 85 and palm rest 39. Therefore, the input by the manipulator in each manipulation space Sp1, Sp2 becomes easier.

Further, the capacitive touch sensor 31 used for the first embodiment is capable of detecting not only the movement of the finger F in the x-y-axis direction along the first manipulation surface 72 but also the movement of the finger F in the z-axis direction that substantially intersects perpendicularly with the first manipulation surface 72. Therefore, the above touch sensor 31 is preferred as the configuration that detects both (i) the relative position of the finger F in the x-y plane and (ii) the manipulation body distance d.

Further, in the first embodiment, by selecting from the submenu images 164, the icons 63 in the selected submenu image 164 are selectable. Thus, the display images 60 have the hierarchical configuration that permits one selection to enter the state where more detail functions are selectable. In such a state, the physical depth in the recessed portion 80 of each manipulation surfaces 72, 74 manipulated by the finger F is set to correspond to the hierarchical depth of each image portion 61 associated with the manipulation by the finger F. Thereby, it becomes easy for the manipulator to grasp the change of the display images 60 in association with the input of the finger F sensuously.

In the first embodiment, the touch sensor 31 and manipulation control portion 33 are also called the “detection device/means” and the “acquisition device/means” in association with each other. The manipulation control portion 33 is also called the “association device/means.” The first manipulation surface 72 is also called the “manipulation surface.” The second manipulation surface 74 is also called the “input auxiliary portion” or “guide portion.” The first bottom surface 81 is also called the “bottom surface.” The finger F of the manipulator is also called the “manipulation body.” The remote manipulating apparatus 100 is called the “manipulating apparatus.” The focus 62 is also called the “first image portion,” and the submenu images 164 are also called the “second image portion.” The “first image portion” and the “second image portion” may be changed suitably.

In this application, Japanese “Syudan” corresponds to English a “means” or a “device.”

### Second Embodiment

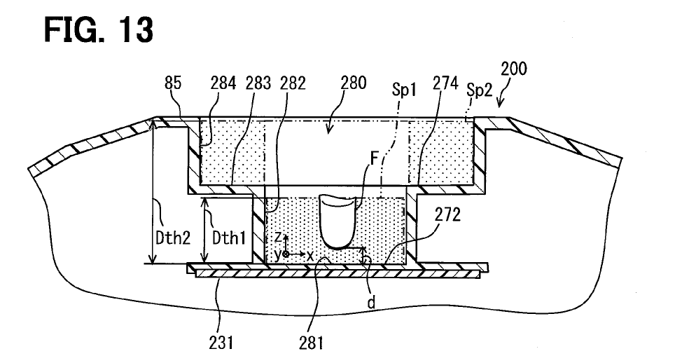

A second embodiment of the present disclosure shown in FIGS. 12 to 14 is a modification of the first embodiment. In a remote manipulating apparatus 200 of the second embodiment, the shape of a recessed portion 280 differs from the shape of the recessed portion 80 (see FIG. 6) of the first embodiment. As shown in FIGS. 12 and 13, the recessed portion 280 of the second embodiment is recessed in the shape of a two-step cylindrical hole from the periphery surface 85. A first bottom surface 281 and a second bottom surface 283 that have a level difference therebetween and two internal peripheral wall surfaces 282 and 284 are formed to the recessed portion 280.

The first bottom surface 281 and the second bottom surface 283 are formed in a plane shape along the x-y plane. The first bottom surface 281 is formed in a substantially circular shape deeper than the second bottom surface 283 relative to the periphery surface 85. The second bottom surface 283 is formed to the outer circumference side of the first bottom surface 281, and is circumferentially formed coaxially with the first bottom surface 281. The second bottom surface 283 is located in the middle between the first bottom surface 281 and periphery surface 85 in the z-axis direction.

The two internal peripheral wall surfaces 282 and 284 are both formed in cylindrical shapes. For the internal peripheral wall surfaces 282 and 284, the deep-side internal peripheral wall surface 282 closer to the first bottom surface 281 than to the periphery surface 85 connects the outer edge of the first bottom surface 281 to the inner edge of the second bottom surface 283. In contrast, the shallow-side internal peripheral wall surface 284 closer to the periphery surface 85 than to the first bottom surface 281 connects the outer edge of the second bottom surface 283 to the periphery surface 85. Each internal peripheral wall surface 282, 284 may be formed along the z-axis direction or may be formed in a tapered shape whose diameter is reduced from the periphery surface 85 toward the first bottom surface 281.

The first manipulation surface 272 and the second manipulation surface 274 are formed to the recessed portion 280. The first manipulation surface 272 is formed to the first bottom surface 281 in a circular shape. The second manipulation surface 274 is formed annularly throughout the second bottom surface 283. The second manipulation surface 274 extends circumferentially in a belt shape along the outer edge of the first bottom surface 281.

The touch sensor 231 is formed in a shape of a disc opposing the entire areas of the first manipulation surface 272 and second manipulation surface 274 in the z-axis direction. Thereby, the touch sensor 231 is capable of detecting not only the moving manipulation of the finger F in the area opposing the first manipulation surface 272 but also the moving manipulation of the finger F in the area opposing the second manipulation surface 274.

As shown in FIG. 13, the first manipulation space Sp1 in the remote manipulating apparatus 200 is defined in the range in which the manipulation body distance d is less than the first threshold distance Dth1 in the area opposing the first manipulation surface 272. The first threshold distance Dth1 is set slightly shorter than the size of the level difference between the first manipulation surface 272 and second manipulation surface 274. Therefore, the first manipulation space Sp1 is defined in the area surrounded by the deep-side internal peripheral wall surface 282. In contrast, the second manipulation space Sp2 is defined in the range in which the manipulation body distance d is equal to or greater than the first threshold distance Dth1 and less than second threshold distance Dth2 in the area opposing the second manipulation surface 274. The second threshold distance Dth2 is set slightly shorter than the depth from the periphery surface 85 to the first manipulation surface 272. Therefore, the second manipulation space Sp2 is defined in the area which is on the outer circumference side of the deep-side internal peripheral wall surface 282 and surrounded by the shallow-side internal peripheral wall surface 284.

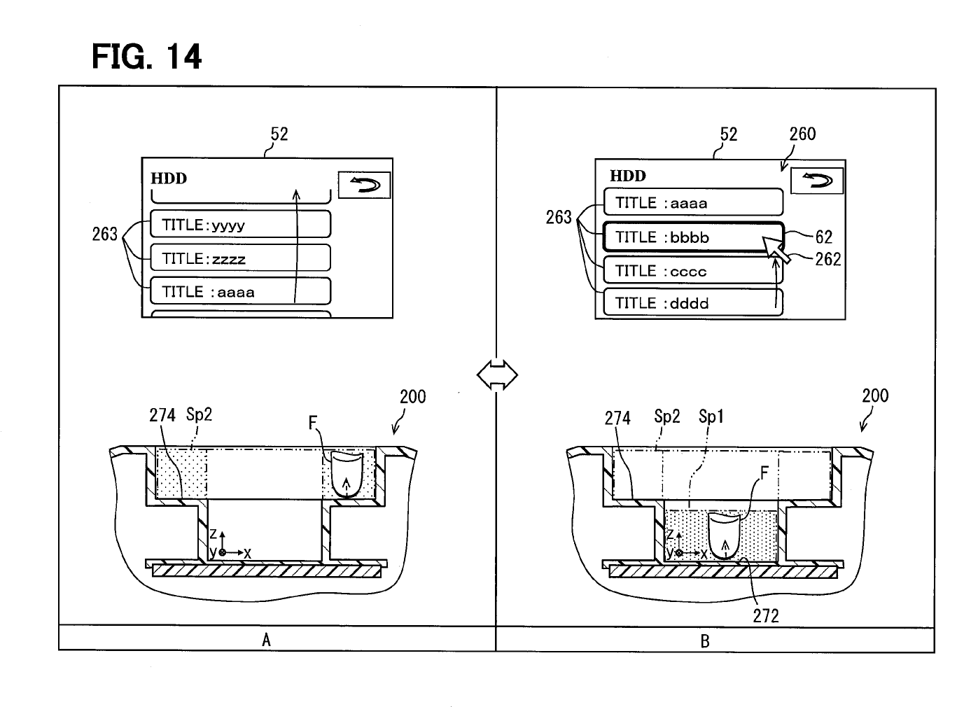

Next, the icon selection inputted to the remote manipulating apparatus 200 is explained based on FIG. 14. A display image 260 shown in FIG. 14 (B) is an audio menu image for manipulating an audio apparatus mounted to the vehicle. The audio menu image contains rack icons 263 associated with audio data, a pointer 262 for selecting from the track icons 263, and a focus 62 for emphasizing the pointer 262.

The manipulator in FIG. 14 (A) inputs a drag on the second manipulation surface 274 with the finger F to the second manipulation surface 274 in the second manipulation space Sp2. Such a shallow manipulation by the manipulator is associated with the track icons 263 of the display screen 52 to scroll the track icons 263 integrally in the up-and-down direction (scroll control). Therefore, the manipulator can move the arbitrary track icon 263 to the center of the display screen 52 by inputting the shallow manipulation of dragging the second manipulation surface 274 with the finger F.

In FIG. 14 (B), the manipulator moves the finger F from the second manipulation space Sp2 to the first manipulation space Sp1. When the finger F is detected in the first manipulation space Sp1, the pointer 262 is displayed on the display screen 52. The manipulator in FIG. 14 (B) inputs a drag on the first manipulation surface 272 with the finger F to the first manipulation surface 272. Such a deep manipulation by the manipulator is associated with the pointer 262 of the display screen 52, and capable of changing the display mode to move the pointer 262 (pointer control). Therefore, the manipulator can superimpose the pointer 262 on the arbitrary track icon 263 by inputting the deep manipulation of dragging the first manipulation surface 272 with the finger F. In this way, the track icon 263 on which the pointer 262 has been superimposed is surrounded by the focus 62. The manipulator can select this arbitrary track icon 263 by inputting a tap on the first manipulation surface 272 with the pointer 262 superimposed on the arbitrary track icon 263.

Even when the above audio menu image is displayed, the association of the moving manipulation with the image portions 262 and 263 is started by inputting a tap to either of the manipulation surfaces 272 and 274 as if the submenu images 164 (see FIG. 8 (B)) are displayed. When the manipulator who has completed the selection of the track icons 263 moves the finger F to the non-adjacent space, the manipulation mode is changed to the non-adjacent mode. Then, when the predefined threshold time Tth elapses after the manipulation mode is changed to the non-adjacent mode, the remote manipulating apparatus 200 enters a state to wait for the icon selection by a next or subsequent manipulator.

Also in the second embodiment described above, the manipulator can perform the shallow manipulation while contacting the second manipulation surface 274. Since the location of the second manipulation space Sp2 is obtainable by the assistance of the second manipulation surface 274, the input in the manipulation space Sp2 becomes easy.

In addition, according to the second embodiment, the second manipulation surface 274 extends in a belt shape while curving along the outer edge of the first manipulation surface 272. Therefore, the manipulator can describe a trajectory of a substantially arc with the finger F while fixing the hand by use of either of the palm rest 39 (see FIG. 2) and periphery surface 85 (see FIG. 12). Thus, the input by the finger F of the manipulator becomes easier by matching the shape of the second manipulation surface 274 with the shape of the trajectory for easy movement of the finger F.

In the second embodiment, the first manipulation surface 272 is also called the “manipulation surface.” The second manipulation surface 274 is also called the “input auxiliary portion” or “guide portion.” The first bottom surface 281 is also called the “bottom surface.” The pointer 262 is also called the “first image portion.” The track icons 263 are also called the “second image portion.” The “first image portion” and the “second image portion” may be changed suitably. The remote manipulating apparatus 200 is also called the “manipulating apparatus.”

### Third Embodiment

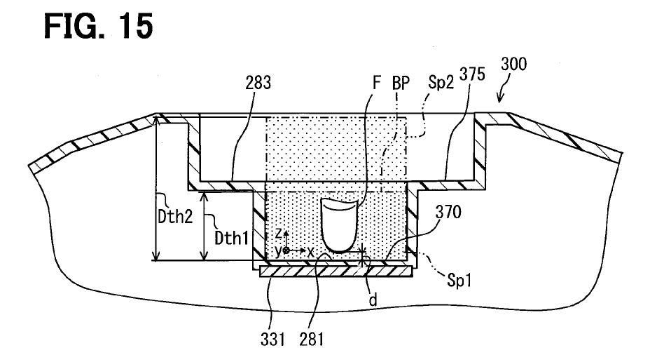

A third embodiment of the present disclosure shown in FIGS. 15 to 17 is a modification of the second embodiment. As shown in FIG. 15, in a remote manipulating apparatus 300 of the third embodiment, a touch sensor 331 is formed in a shape of a disc opposing the entire area of the first bottom surface 281 in the z-axis direction. By such a reduction of the touch sensor 331, the second bottom surface 283 forms a shallow manipulation guide surface 375 instead of the second manipulation surface 274 (see FIG. 13). The shallow manipulation guide surface 375 is capable of assisting the input by the finger F in the second manipulation space Sp2 mentioned later by supporting the manipulator's hand. The shallow manipulation guide surface 375 is located to be adjacent to a virtual border plane BP between the first manipulation space Sp1 and second manipulation space Sp2, and is formed along the border plane BP. By such a configuration, the shallow manipulation guide surface 375 is capable of showing the location of the border plane BP to the manipulator who performs blind manipulation. In contrast, the manipulation surface of the third embodiment is substantially the same as the first manipulation surface 272 (see FIG. 13) of the second embodiment, formed to the first bottom surface 281, and set as a manipulation surface 370. The touch sensor 331 detects the moving manipulation that moves the finger F in the area opposing the manipulation surface 370.

In the above remote manipulating apparatus 300, the first manipulation space Sp1 is defined in the range in which the manipulation body distance d is less than the first threshold distance Dth1 in the area opposing the manipulation surface 370. In contrast, the second manipulation space Sp2 is defined in the range in which the manipulation body distance d is equal to or greater than the first threshold distances Dth1 and less than second threshold distance Dth2 in the area opposing the manipulation surface 370. That is, the second manipulation space Sp2 is not formed in the area opposing the second bottom surface 283.

The remote manipulating apparatus 300 defines a plurality of manipulation modes including a contact manipulation mode and an in-air manipulation mode together with the non-adjacent mode. The contact manipulation mode is the manipulation mode when the finger F is located in the first manipulation space Sp1, and corresponds to the deep manipulation mode in the first embodiment. In contrast, the in-air manipulation mode is the manipulation mode when the finger F is located in the second manipulation space Sp2, and corresponds to the shallow manipulation mode in the first embodiment.

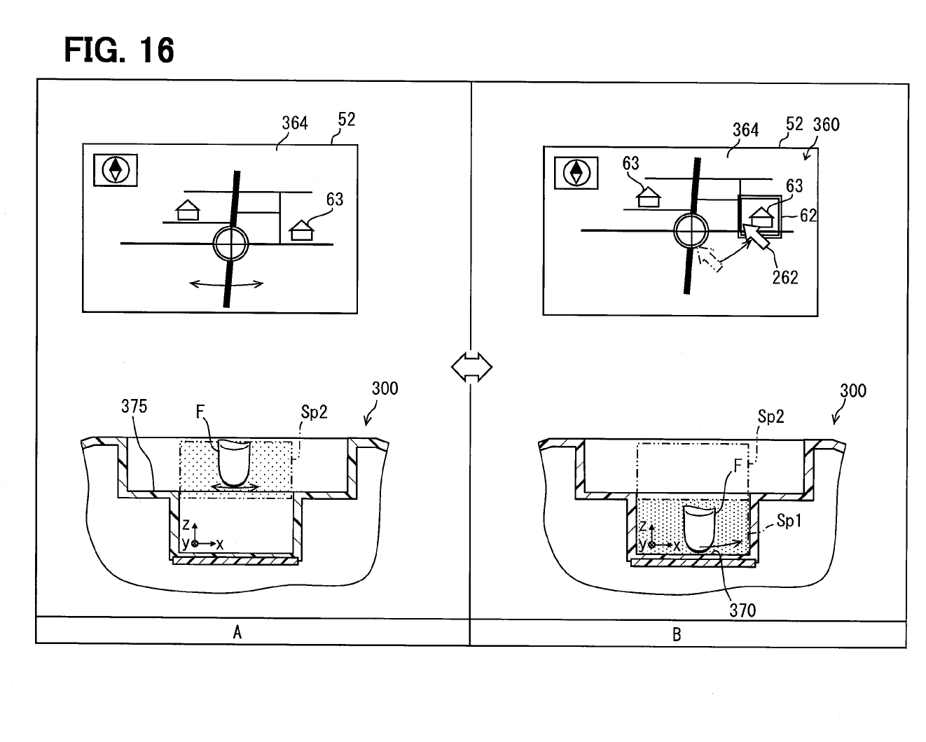

The icon selection manipulation inputted to the above remote manipulating apparatus 300 is explained based on FIG. 16. A display image 360 shown in FIG. 16 (B) is a navigation image that shows a route to a destination set by the manipulator. The navigation image includes the multiple icons 63 associated with predetermined functions, the pointer 262 for selecting the icons 63, and a map 364 that shows forms of roads around the vehicle. In addition, the display image 360 also includes the focus 62 that emphasizes the icon 63 superimposed on the pointer 262.

The manipulator in FIG. 16 (A) inputs the moving manipulation of the finger F in the second manipulation space Sp2 while laying the thumb and little finger instead of the forefinger F on the shallow manipulation guide surface 375. Thus, the moving manipulation that moves the finger F along the x-y plane in the second manipulation space Sp2 is defined as the “in-air manipulation,” and associated with the map 364 displayed on the display screen 52 to permit the up-and-down and right-and-left movement on the map 364 (map control). Therefore, the manipulator can move the map 364 to display the arbitrary icon 63 on an easily selectable location by inputting the in-air manipulation.

In FIG. 16 (B), the manipulator moves the finger F from the second manipulation space Sp2 to the manipulation surface 370 in the first manipulation space Sp1. When the finger F is detected in the first manipulation space Sp1, the pointer 262 is displayed on the display screen 52. The manipulator in FIG. 16 (B) inputs a drag on the manipulation surface 370 with the finger F to the manipulation surface 370. Thus, the moving manipulation that moves the finger F along the x-y plane in the first manipulation space Sp1 is defined as the “contact manipulation,” and associated with the pointer manipulation. Therefore, the manipulator can superimpose the pointer 262 on the arbitrary icon 63 by inputting the contact manipulation of dragging the manipulation surface 370 with the finger F. In such a state, the manipulator can select the arbitrary icon 63 superimposed on the pointer 262 and surrounded by the focus 62 by inputting a tap to the manipulation surface 370.

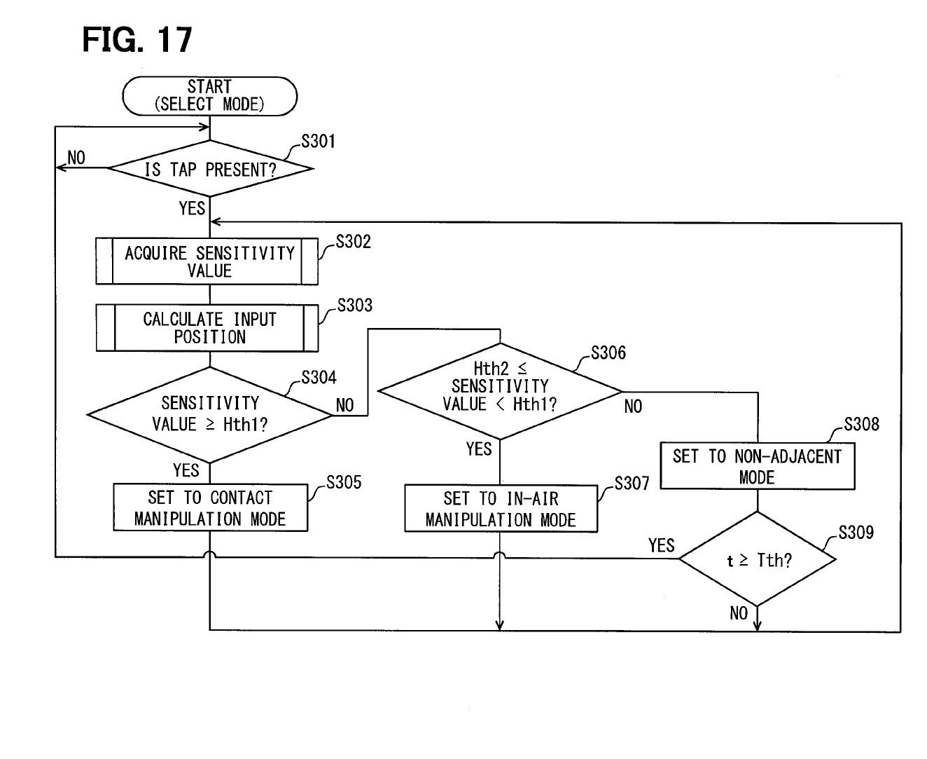

The manipulation mode selection performed by the manipulation control portion 33 (see FIG. 1) for the above icon selection is explained in detail based on FIG. 17.

In S301, the presence of a tap on the manipulation surface 370 is determined based on variation of the output acquired from the touch sensor 331. When the tap is determined to be absent in S301, the wait state of the remote manipulating apparatus 300 is maintained by repeating the determination of S301. On the other hand, when the tap is determined to be present in S301, the substantially same processes of S302 and S303 as those of S102 and S103 (see FIG. 9) of the first embodiment take place.

In S304, it is determined whether the finger F is in the first manipulation space Sp1. That is, it is determined whether the sensitivity value is equal to or greater than the first sensibility threshold Hth1. When a positive determination is made in S304, the flow proceeds to S305. In S305, the manipulation mode is set to the contact manipulation mode, and the flow returns to S302.

In S306 when a negative determination in S304, it is determined whether the finger F is in the second manipulation space Sp2. That is, it is determined whether the sensitivity value is less than the first sensibility threshold Hth1 and equal to or greater than the second sensibility threshold Hth2. When a positive determination is made in S306, the flow proceeds to S307. In S307, the manipulation mode is set to the in-air manipulation mode, and the flow returns to S302.

In S308 when a negative determination is made in S306, the manipulation mode is set to the non-adjacent mode, and the flow proceeds to S309. In this S308, when the manipulation mode is changed from the contact manipulation mode or in-air manipulation mode to the non-adjacent mode, the count of the elapsed time t after transition to the non-adjacent mode is started.

In S309, it is determined whether the elapsed time t that has started to be counted in the latest S308 or previous S308 has become greater than the threshold time Tth. When a positive determination is made in S309, the flow returns to S301. Thereby, the remote manipulating apparatus 300 transitions to the wait state. On the other hand, when a negative determination is made in S309, the flow returns to S302.

As in the third embodiment described above, even when the second manipulation space Sp2 is not formed in the area opposing the second bottom surface 283, the shallow manipulation guide surface 375 formed to the second bottom surface 283 may show the location of the border plane BP. Therefore, the manipulator can obtain the location of the border plane BP easily in blind manipulation. Therefore, the remote manipulating apparatus 300 is capable of acquiring a high manipulation capability of the in-air manipulation.

In addition, the manipulator can perform the input with the finger F in the second manipulation space Sp2 contiguous to the shallow manipulation guide surface 375 while permitting the shallow manipulation guide surface 375 to contact the thumb and little finger to stabilize the hand. Such assistance by the shallow manipulation guide surface 375 can make easier the input in the second manipulation space Sp2, even in the configuration in which cost reduction is intended by reducing the detection range of the touch sensor 331.

In the third embodiment, the shallow manipulation guide surface 375 is also called the “input auxiliary portion.” The map 364 is also called the “second image portion.” The “second image portion” may be changed suitably. The remote manipulating apparatus 300 is also called the “manipulating apparatus.”

### Fourth Embodiment

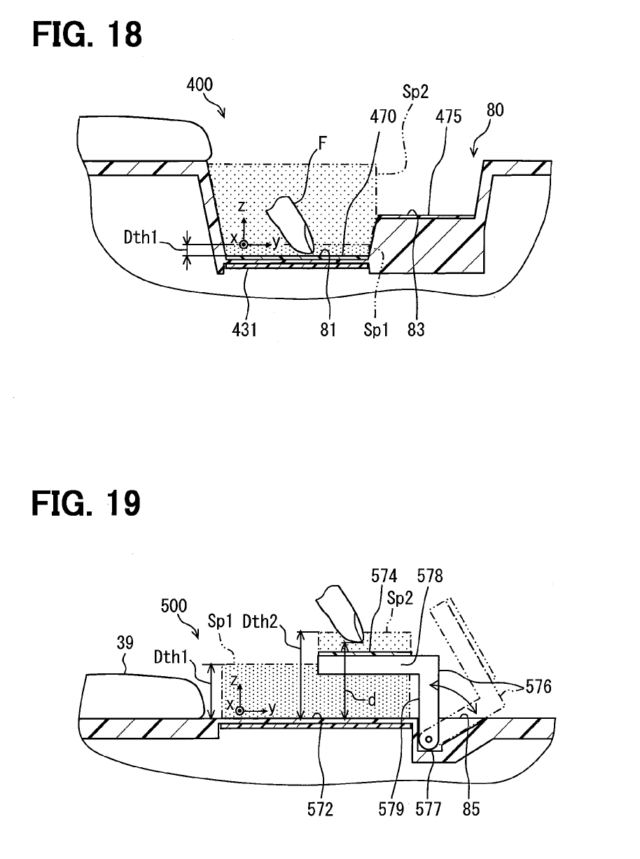

A fourth embodiment of the present disclosure shown in FIG. 18 is a modification combining the control of the third embodiment with the configuration such as the recessed portion 80 in the first embodiment. In a remote manipulating apparatus 400 of the fourth embodiment, a touch sensor 431 is made smaller than the touch sensor 31 (see FIG. 6) of the first embodiment, and formed in a rectangular shape opposing the entire area of the first bottom surface 81 in the z-axis direction. The touch sensor 431 detects the moving manipulation that moves the finger F in the area opposing a manipulation surface 470 formed to the first bottom surface 81.

In the remote manipulating apparatus 400, the first threshold distance Dth1 is set to, for example, about 0.3 cm to be equal to or under a half of the depth from the second bottom surface 83 to the first bottom surface 81. Therefore, the first manipulation space Sp1 is defined in the range adjacent to the first bottom surface 81 in the area opposing the manipulation surface 470. In contrast, the second manipulation space Sp2 is expanded in the z-axis direction from the second bottom surface 83 toward the first bottom surface 81 to contain the range whose lower limit is closer to the first bottom surface 81 than to the second bottom surface 83.

Because of the setting of the above first threshold distance Dth1, a shallow manipulation guide surface 475 formed to the second bottom surface 83 is capable of showing the location of the second manipulation space Sp2 to the manipulator who performs blind manipulation. Therefore, the manipulator can certainly input the moving manipulation in the second manipulation space Sp2 by moving the finger F to the location of the shallow manipulation guide surface 475 in the z-axis direction. Therefore, the remote manipulating apparatus 400 is capable of acquiring the manipulation capability in the in-air manipulation.

In addition, in the fourth embodiment, since the second manipulation space Sp2 is expanded, the input to the second manipulation space Sp2 by blind manipulation becomes easier. The input auxiliary action synergisticly employing (i) the setting value of the first threshold distance Dth1 and (ii) the provision of the shallow manipulation guide surface 475 further improves the manipulation capability of the remote manipulating apparatus 400.

In the fourth embodiment, the shallow manipulation guide surface 475 is called the “input auxiliary portion.” The remote manipulating apparatus 400 is called the “manipulating apparatus.”

### Fifth Embodiment

A fifth embodiment of the present disclosure shown in FIG. 19 is another modification of the first embodiment. The recessed portion 80 (see FIG. 5) is omitted from a remote manipulating apparatus 500 of the fifth embodiment. Thereby, a first manipulation surface 572 is formed to a flat surface having no level difference from the periphery surface 85.

In contrast, a second manipulation surface 574 is formed of a movable member 576 in the area opposing the first manipulation surface 572. The movable member 576 supports the second manipulation surface 574, and has an L-shaped cross section in the z-y plane. The movable member 576 has an input surface portion 578, a strut portion 579, and a hinge portion 577.

The input surface portion 578 is formed in a rectangular plate shape along the x-y plane, and located remote from the first manipulation surface 572. The upper surface of both surfaces of the input surface portion 578, the upper surface being remote from the first manipulation surface 572, forms the second manipulation surface 574. The strut portion 579 extends from the front end of both ends of the input surface portion 578 in the y-axis direction toward the periphery surface 85, the front end being remote from the palm rest 39. The strut portion 579 is formed in a rectangular plate shape along the z-x plane. The hinge region 577 is formed at the top end of the strut portion 579 in the extending direction. The hinge portion 577 makes the movable member 576 pivotable about the x-axis. Therefore, the movable member 576 is capable of tilting forward in the y-axis direction to be remote from the first manipulation surface 572 together with the second manipulation surface 574 (see the two-dot chain line of FIG. 19).

In the above remote manipulating apparatus 500, the first threshold distance Dth1 is defined to fit the height from the first manipulation surface 572 to input surface portion 578. Therefore, the first manipulation space Sp1 is defined in the range lower than the input surface portion 578 in the z-axis direction in the area opposing the first manipulation surface 572. In contrast, the second manipulation space Sp2 is defined in the range in which the manipulation body distance d is less than the second threshold distance Dth2 in the area opposing the second manipulation surface 574.

Also in the fifth embodiment described above, the same advantageous effect as the first embodiment is obtained, so that the manipulator can receive the input assistance using the second manipulation surface 574 when performing the input into the second manipulation space Sp2. Therefore, the remote manipulating apparatus 500 is capable of obtaining the high manipulation capability in the input to the second manipulation surface 574.

In addition, in the fifth embodiment, the second manipulation surface 574 is formed in the area opposing the first manipulation surface 572. Therefore, the enlargement of the remote manipulating apparatus 500 due to the addition of the second manipulation surface 574 may be avoided. In addition, since the second manipulation surface 574 is spaced apart from the first manipulation surface 572, the area of the first manipulation surface 572 may be prevented from decreasing. Therefore, the remote manipulating apparatus 500 can ensure not only the manipulation capability in the input in the second manipulation space Sp2 but also the manipulation capability in the input in the first manipulation space Sp1.

Additionally, according to the fifth embodiment, when the change of the image portions 61 (see FIG. 7) targeted for manipulation is unnecessary, the second manipulation surface 574 is capable of retracting from the area opposing the first manipulation surface 572. Therefore, when the second manipulation surface 574 is unnecessary, the obstruction to the input to the first manipulation surface 572 is avoidable.

In the fifth embodiment, the first manipulation surface 572 is called the “manipulation surface.” The second manipulation surface 574 is called the “input auxiliary portion” or “guide portion.” The movable member 576 is called the “movable support portion.” The remote manipulating apparatus 500 is called the “manipulating apparatus.”

### Sixth Embodiment

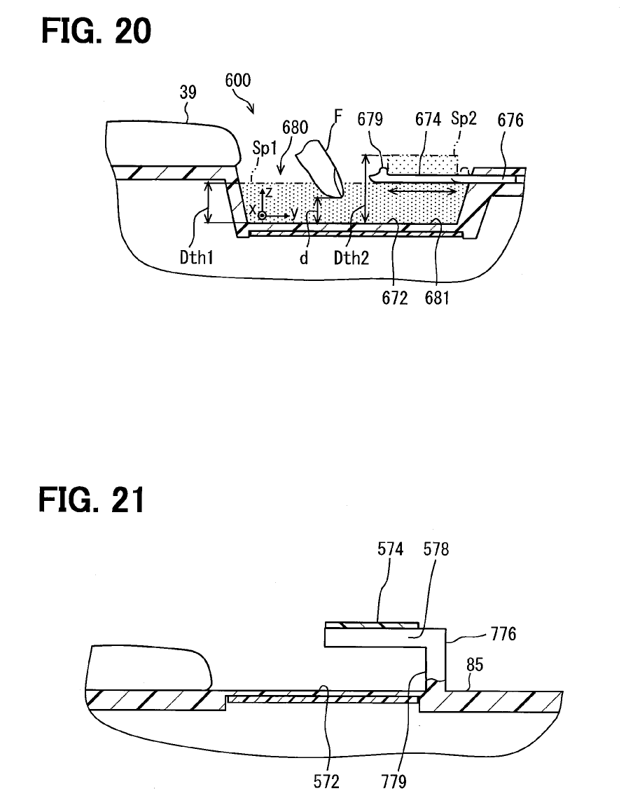

A sixth embodiment of the present disclosure shown in FIG. 20 is a modification of the fifth embodiment. A recessed portion 680 is formed in a remote manipulating apparatus 600 of the sixth embodiment. A first manipulation surface 672 is formed to a bottom surface 681 of the recessed portion 680. In contrast, a second manipulation surface 674 is formed to a lid-like lid member 676 that covers part of the opening of the recessed portion 680. The second manipulation surface 674 is formed to the upper surface of both surfaces of the lid member 676, the upper surface being spaced apart from the first manipulation surface 672.

The lid member 676 supports the second manipulation surface 674, and is formed in a plate shape along the x-y plane. The lid member 676 is formed movably in the y-axis direction, and can be received in the peripheral portion of the recessed portion 680 by moving forward away from the palm rest 39 (see the two-dot chain line of FIG. 20). Thereby, the lid member 676 moves apart from the first manipulation surface 672 together with the second manipulation surface 674 to permit the second manipulation surface 674 to retract from the area opposing the first manipulation surface 672. A hook portion 679 for easy movement is formed to the lid member 676. The hook portion 679 projects from the back end of the lid member 676 in the y-axis direction towards the direction separating away from the bottom surface 681 along the z-axis direction. The manipulator can pull out the lid member 676, which has been received, backward and close to the palm rest 39 by placing the finger F to the hook portion 679.

In the above remote manipulating apparatus 600, the first threshold distance Dth1 is defined to fit the height from the first manipulation surface 672 to the lid member 676. Therefore, the first manipulation space Sp1 is defined in the range lower than the lid member 676 in the z-axis direction in the area opposing the first manipulation surface 672. In contrast, the second manipulation space Sp2 is defined in the range in which the manipulation body distance d is less than the second threshold distance Dth2 in the area opposing the second manipulation surface 674.

Also in the sixth embodiment described above, by obtaining the same advantageous effect as the first embodiment, the manipulator can use the assistance of the input by the second manipulation surface 674 when performing the input into the second manipulation space Sp2. Therefore, the remote manipulating apparatus 600 is capable of obtaining the high manipulation capability in the input to the second manipulation surface 674.

In addition, as in the sixth embodiment, by providing the lid member 676 slidable in the y-axis direction, the second manipulation surface 674 can be retracted from the area opposing the first manipulation surface 672. Therefore, when the second manipulation surface 674 is unnecessary, the obstruction to the input to the first manipulation surface 672 is avoidable.

In the sixth embodiment, the first manipulation surface 672 is also called the “manipulation surface.” The second manipulation surface 674 is also called the “input auxiliary portion” or “guide portion.” The lid member 676 is also called the “movable portion.” The remote manipulating apparatus 600 is also called the “manipulating apparatus.”

### Another Embodiment

The multiple embodiments of the present disclosure have been described above. The present disclosure is not limited to the above embodiments, and is applicable to various embodiments and the combinations thereof without departing from the contents of the present disclosure.

In a first modification of the above fifth embodiment shown in FIG. 21, the second manipulation surface 574 is formed to a fixing member 776 standing from the periphery surface 85. The fixing member 776 has the input surface portion 578 and a strut portion 779. The support portion 779 is secured to the periphery surface 85. As in the above first modification, the second manipulation surface 574 may not be retracted from the area opposing the first manipulation surface 572.

In a modification of the above embodiments, a push button for selecting the icon 63 optionally is provided to be adjacent to the recessed portion 80. While superimposing the pointer 262 and focus 62 on the arbitrary icon 63, the manipulator can select the function of the icon 63 by pushing the push button.

In a modification of the above embodiments, a pressure sensitive touch sensor that detects manipulation by the finger F by detecting a pressure applied by the finger F is used as the “detection device/means.” In contrast, an infrared sensor that measures the manipulation body distance d by infrared light is used as the “acquisition device/means.” In another modification, a camera that captures the neighborhood of each manipulation surface and an image analysis circuit that acquires the manipulation body distance d by analyzing images captured by the camera are used as the “acquisition device/means.”

In a modification of the above embodiments, a display using a plasma display panel and a display using organic electroluminescence form the “display screen.” Further, in another modification, a windshield and a combiner that is provided to the upper surface of an instrument panel are set as the “display screen.” A display apparatus that projects images on the windshield and the combiner by use of a projection device/means such as a projector is contained in the navigation apparatus 50 as a component forming the display screen 52.

In a modification of the above embodiments, hysteresis is provided to the first threshold distance Dth1 and second threshold distance Dth2. Specifically, based on the fact that the finger F is located in the first manipulation space Sp1, the first threshold distance Dth1 is increased. The second threshold distance Dth2 is increased based on the fact that the finger F is located in the second manipulation space Sp2. In such a configuration, the manipulation by the finger F in each space Sp1 and Sp2 becomes easier.

In the above embodiments, the “first image portion” and the “second image portion” exemplified multiple times may be changed suitably. As mentioned above, in the above embodiments, the multiple functions (also called the section, the means, or the device) provided by the manipulation control portion 33 that executes programs may be provided by hardware and software different from the above control apparatus or a combination thereof. For example, functions such as the “association section” and “acquisition section” may be provided by a circuit of the hardware that achieves predetermined functions without programs.

The above-mentioned embodiments have explained the examples in which the present disclosure is applied to the remote manipulating apparatuses used for the display system mounted to the vehicle. However, the present disclosure is applicable also to the so-called touch-panel manipulating apparatus configured integrally with the display screen. Further, the manipulating apparatus to which the present disclosure is applied is employable generally in the display systems used for not only vehicles but also various transport apparatuses and various information terminals.

As mentioned above, in this application, Japanese “Shudan” corresponds to English a “means” or a “device.”

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

1. A manipulating apparatus that manipulates an image displayed on a display screen by an input with a manipulation body performed to a manipulation surface,
the manipulating apparatus comprising:
a detection device that detects movement of the manipulation body;
an acquisition device that acquires a manipulation body distance from the manipulation surface to the manipulation body;
an association device that
distinguishes a first movement of the manipulation body detected in a first manipulation space in which the manipulation body distance is less than a predefined threshold distance from a second movement of the manipulation body detected in a second manipulation space in which the manipulation body distance is greater than the predefined threshold distance,
associates the first movement of the manipulation body and the second movement of the manipulation body, respectively, with a first image portion displayed on the display screen and a second image portion displayed on the display screen, the second image portion being different from the first image portion, and
changes a display mode of at least one of the first image portion and the second image portion; and
an input auxiliary portion formed to a location spaced apart from the manipulation surface by a distance equal to or greater than the threshold distance.

2. The manipulating apparatus according to claim 1, wherein:
the input auxiliary portion is located in the second manipulation space; and
the detection device further detects the second movement of the manipulation body along the input auxiliary portion.

3. The manipulating apparatus according to claim 1, wherein:
the input auxiliary portion is formed along a virtual border plane in between the first manipulation space and the second manipulation space; and
the association device associates, with the second image portion, the second movement of the manipulation body in the second manipulation space that opposes the manipulation surface and is adjacent to the input auxiliary portion.

4. The manipulating apparatus according to claim 3, wherein;
the border plane is closer to the manipulation surface than to the input auxiliary portion.

5. The manipulating apparatus according to claim 1, wherein:
the input auxiliary portion is provided in an area opposing the manipulation surface, and is spaced apart from the manipulation surface.

6. The manipulating apparatus according to claim 1, wherein:
the input auxiliary portion is formed in a belt shape along an outer edge of the manipulation surface.

7. The manipulating apparatus according to claim 1, further comprising:
a movable support portion that supports the input auxiliary portion and moves apart from the manipulation surface together with the input auxiliary portion.

8. The manipulating apparatus according to claim 1, wherein:
the manipulation surface is formed to a bottom surface of a recessed portion provided to the manipulating apparatus.

9. The manipulating apparatus according to claim 1, wherein:
the detection device detects the manipulation body distance together with movement of the manipulation body to function also as the acquisition device.

10. The manipulating apparatus according to claim 1, wherein:
the input auxiliary portion is located to at least one of a directly above area spaced apart from the manipulation surface by a distance equal to or greater than the threshold distance and an adjacent area adjacent to the directly above area.

11. A manipulating apparatus comprising:
a plane-shaped capacitive touch panel; and
a guide portion that covers part of the capacitive touch panel and guides an input manipulation to the capacitive touch panel.

12. A manipulating apparatus that manipulates an image displayed on a display screen by an input with a manipulation body performed to a manipulation surface,
the manipulating apparatus comprising:
means for detecting movement of the manipulation body;
means for acquiring a manipulation body distance from the manipulation surface to the manipulation body;
means for
distinguishing a first movement of the manipulation body detected in a first manipulation space in which the manipulation body distance is less than a predefined threshold distance from a second movement of the manipulation body detected in a second manipulation space in which the manipulation body distance is greater than the predefined threshold distance,
associating the first movement of the manipulation body and the second movement of the manipulation body, respectively, with a first image portion displayed on the display screen and a second image portion displayed on the display screen, the second image portion being different from the first image portion, and
changing a display mode of at least one of the first image portion and the second image portion; and
means for assisting the second movement of the manipulation body in the second manipulation space.
